(19) United States
(12) Patent Application Publication
(10) Pub. No.: US 2009/0213104 A1
(43) Pub. Date: Aug. 27, 2009

(54) SOURCE DRIVER CIRCUIT

(75) Inventors: Hiroshi Yaguma, Ukyo-Ku (JP); Akio Kamimurai, Ukyo-Ku (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/345,518

(22) Filed: Dec. 29, 2008

(30) Foreign Application Priority Data
Dec. 28, 2007 (JP) JP2007-341085

(51) Int. Cl. G09G 5/00

(52) U.S. Cl. 345/211

(57) ABSTRACT

A plurality of source amplifiers, arranged for each of a plurality of data lines, generate a drive voltage corresponding to brightness data indicating pixel brightness, to supply corresponding data lines. An output terminal of each source amplifier is connected to a corresponding data line. A high side transistor is arranged between a power supply line and the output terminal, and a low side transistor is arranged between a ground line and the output terminal. A first capacitor is arranged between the output terminal and a gate of the high side transistor, and a second capacitor is arranged between the output terminal and a gate of the low side transistor. Respective pads that function as the output terminal of each of the source amplifiers are disposed along one side of a semiconductor substrate in which a source driver is integrated. The first capacitor and the second capacitor are disposed along one side, at positions adjacent to the pads.

### BACKGROUND OF THE INVENTION

1. Field of the Invention

The present invention relates to driving technology for liquid crystal panels, and in particular, to source drivers which drive data lines.

2. Description of the Related Art

A liquid crystal panel is provided with a plurality of data lines, a plurality of scanning lines disposed orthogonally to the data lines, and a plurality of TFTs (Thin Film Transistors) disposed in a matrix form at intersection points of the data lines and the scanning lines. In order to drive the liquid crystal panel, a gate driver circuit which sequentially selects the plurality of scanning lines, and a source driver circuit which applies a voltage corresponding to brightness to each of the data lines, are provided.

The source driver circuit is provided with a plurality of source amplifiers arranged for each data line, along one side of the liquid crystal panel, and is integrated on one semiconductor substrate. Each source amplifier receives brightness data of a differential signal conforming to an RSDS (Reduced Swing Differential Signaling) standard or the like, outputted from a timing controller, and drives the data lines.

Patent Document 1: Japanese Patent Application, Laid Open No. 2002-176350

A pad is provided in order to connect a data line to an output terminal of each source amplifier. Since the number of pads is increasing with increasing size of liquid crystal panels and higher pixel quality, circuit elements that form a source amplifier and pad layout have a large effect on overall chip area of an IC. Since circuit area is directly connected to cost, chip shrink by effective layout is desired.

### SUMMARY OF THE INVENTION

The present invention has been made with regard to these circumstances and provides source drivers that have an effective layout.

An embodiment of the present invention relates to a source driver which drives a plurality of data lines of a liquid crystal panel. The source driver is provided with a plurality of source amplifiers, which are arranged for each of the plurality of data lines, and which generate a drive voltage corresponding to brightness data indicating pixel brightness, to supply corresponding data lines. Each source amplifier includes an output terminal to which a corresponding data line is connected, a high side transistor arranged between a first power supply line and the output terminal, a low side transistor arranged between a second power supply line and the output terminal, a first capacitor arranged between the output terminal and a control terminal of the high side transistor, and a second capacitor arranged between the output terminal and a control terminal of the low side transistor. A plurality of pads that function as output terminals of the plurality of source amplifiers are disposed along at least one side of a semiconductor substrate in which the present source driver is integrated. The first capacitor and the second capacitor are disposed along the one side at positions adjacent to the pads.

According to this embodiment, by disposing the capacitors in a peripheral region in which the pads are disposed, it is possible to utilize space effectively.

The first capacitor and the second capacitor of each source amplifier may be disposed on either side of a pad functioning as an output terminal of the source amplifier. In such cases, it is possible to make a wire connection between the first and second capacitors and the output terminal pad more efficient.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram showing a configuration of a liquid crystal display provided with source drivers according to an embodiment;

FIGS. 2A and B are circuit diagrams showing a configuration of a source driver according to the embodiment; and

FIG. 3 is a layout diagram of the source driver provided with source amplifiers of FIG. 2.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, “a state in which a member A is connected to a member B” includes cases in which the member A and the member B are directly and physically connected, and cases in which the member A and the member B are indirectly connected via another member that does not affect an electrical connection state. Similarly, “a state in which a member C is arranged between a member A and a member B” includes, in addition to cases in which the member A and the member C, or the member B and the member C are directly connected, cases in which the members are indirectly connected via another member that does not affect an electrical connection state.

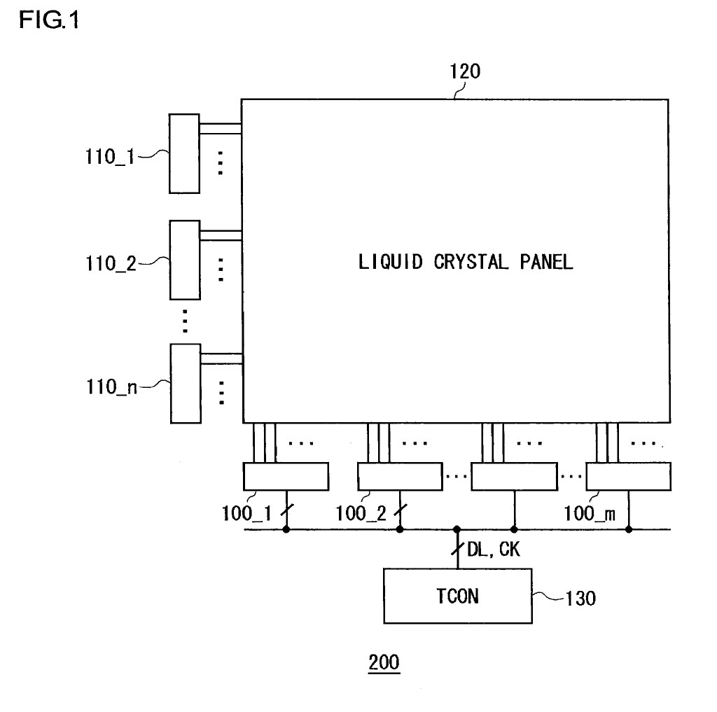

FIG. 1 is a circuit diagram showing a configuration of a liquid crystal display 200 provided with source drivers 100 according to an embodiment. The liquid crystal display 200 is provided with the source drivers 100, gate drivers 110, a liquid crystal panel 120, and a timing controller 130.

The liquid crystal panel 120 is provided with a plurality of data lines and a plurality of scanning lines, and pixel circuits disposed in a matrix form are arranged at intersection points of the data lines and the scanning lines. The gate drivers 110 receive data from the timing controller 130, give a voltage in sequence to the plurality of scanning lines, and make selections. The source drivers 100 receive brightness data DL indicating brightness of each pixel outputted from the timing controller 130, together with a clock CK synchronized with the brightness data DL, and drive the plurality of data lines of the liquid crystal panel 120.

The source drivers 100_1 to 100_{—}m are disposed along one side of the liquid crystal panel 120. The number m of source drivers 100 is determined in accordance with the resolution of the liquid crystal panel 120. The source drivers 100 form a function IC integrated as a unit on one semiconductor substrate. Pluralities of output terminals of the source drivers 100 are respectively connected to the data lines. Furthermore, brightness data of each pixel from the timing controller 130 is inputted to data input terminals of the source drivers 100.

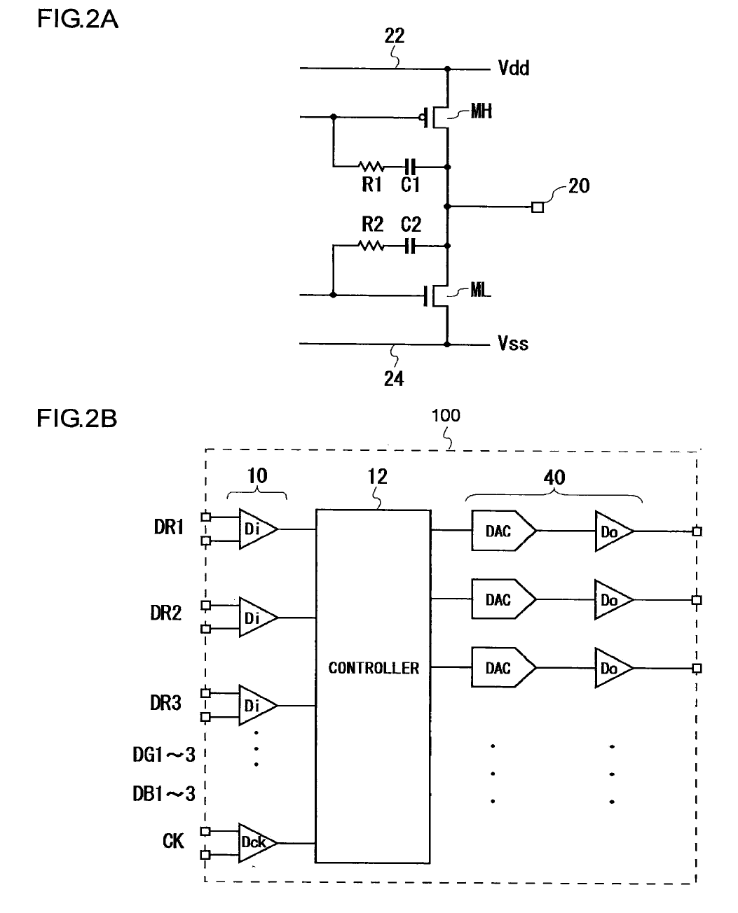

FIGS. 2A and 2B are circuit diagrams showing a configuration of the source driver 100 according to the embodiment.

FIG. 2B is an overall configuration of a source driver 100. The source driver 100 receives brightness data DL (DR1 to DR3, DG1 to DG3, and DB1 to DB3) for each RGB, and a clock CK from the timing controller 130. Each of the brightness data DL and the clock CK is inputted as a differential signal conforming to an RSDS standard. Each of the brightness data DL is latched at timing of both a positive edge and a negative edge of the CK clock. Therefore, in the source drivers 100 of FIG. 1, each RGB has a data amount of 6 bits. The present invention is not limited thereto, and expansion to any number of bits is possible. Furthermore, with respect to data transfer method, there is no limitation to the RSDS standard.

The source driver 100 is provided with input drivers 10, a controller 12, and driver units 40. FIG. 2B shows only a circuit block for the brightness data DR, and circuit blocks for the brightness data DG and DB are omitted.

The input drivers 10 include a plurality of data input drivers Di which perform conversion of the differential signal brightness data to single end, and a clock driver Dck which converts a clock of the differential signal to single end. An output signal of each driver is inputted to the controller 12.

The controller 12 receives the output signal from the input drivers 10. The controller 12 receives respective bits DR1 to DR3, DG1 to DG3, and DB1 to DB3, of the brightness data, and generates a drive signal, as a digital signal, for each data line.

The driver units 40 are provided with digital-to-analog converters DAC and output drivers (source amplifiers) Do, arranged for each of the plurality of data lines LD. Digital brightness data for each data line is latched and inputted to each of the digital-to-analog converters DAC. The digital-to-analog converters DAC perform digital-to-analog conversion on corresponding brightness data. The output drivers Do supply output voltage of the digital-to-analog converters DAC to the data lines LD. Well-known technology may be used for driver circuits for the data lines LD based on the brightness data for each pixel.

FIG. 2A is a circuit diagram showing a configuration of a source amplifier Do. FIG. 2A shows only an output stage of the source amplifier Do; and a differential amplifier provided at an initial stage, an amplifying stage provided at an intermediate stage, and bias circuits therefor, are omitted. Any configuration and layout may be used for the omitted circuits.

The source amplifier Do is provided with an output terminal 20, a first power supply line (referred to below as power supply line) 22, a second power supply line (referred to below as ground line) 24, a high side transistor MH, a low side transistor ML, a first capacitor C1, a first resistor R1, a second capacitor C2, and a second resistor R2.

The output terminal 20 of each source amplifier Do is connected to a corresponding data line DL. The high side transistor MH is a P-channel MOSFET (Metal Oxide Semiconductor Field Effect Transistor), and is arranged between the power supply line 22 and the output terminal 20. The low side transistor ML is an N-channel MOSFET, and is arranged between the ground line 24 and the output terminal 20. The high side transistor MH and the low side transistor ML form a so-called push-pull configuration output stage.

The first capacitor C1 is arranged between the output terminal 20 and a control terminal (gate) of the high side transistor MH. The first resistor R1 is arranged in series with the first capacitor C1. In a similar way, the second capacitor C2 is arranged between the output terminal 20 and a gate of the low side transistor ML. The second resistor R2 is arranged in series with the second capacitor C2. The first capacitor C1, the second capacitor C2, the first resistor R1, and the second resistor R2 are provided for the purpose of phase compensation.

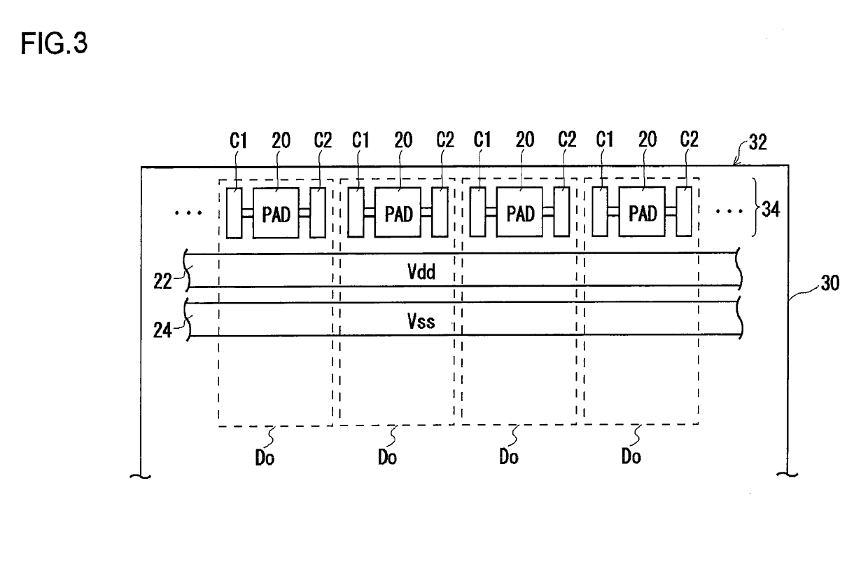

FIG. 3 is a layout diagram of the source driver 100 provided with the source amplifiers Do of FIG. 2. The plurality of source amplifiers Do are disposed along one side 32 of the semiconductor substrate 30.

A plurality of pads PAD function as the output terminals 20 of the plurality of source amplifiers Do. The plurality of pads PAD are disposed along the one side 32 of the semiconductor substrate 30, in a peripheral portion 34 of the semiconductor substrate 30 on which the source driver 100 is integrated.

The power supply line 22 and the ground line 24 are formed adjacently on an inner side of a region in which the pads PAD are formed.

The first capacitor C1 and the second capacitor C2 are MIM (Metal Insulator Metal) capacitors, and are disposed along the one side 32, at positions adjacent to the pads PAD, in a peripheral portion of the semiconductor substrate 30. FIG. 3 shows upper face electrodes of the MIM capacitors.

Efficiency of a layout according to the present embodiment is considered. In order to make a comparison, if cases are considered in which the first capacitor C1 and the second capacitor C2 are formed in a region between the pads PAD and the power supply line 22, a waste of space occurs between the plurality of adjacent pads in such cases.

In contrast to this, according to the layout of FIG. 3, since the two capacitors are disposed in spaces between the adjacent pads PAD, it is possible to reduce the wasted space. By reduction of the wasted space, it is possible to realize chip shrink, and thus it is possible to reduce chip cost.

Preferably, the first capacitor C1 and the second capacitor C2 of each source amplifier Do are disposed on either side of the pads PAD that function as the output terminals 20 of the source amplifiers Do. The first capacitor C1 and the second capacitor C2 must be electrically connected via wiring to the respective output terminals 20. Therefore, by disposing the capacitors on either side of the output terminals 20, it is possible to lay wiring of each of the first capacitor C1 and the second capacitor C2 to be shortest and to be of equal distance.

While the preferred embodiments of the present invention have been described using specific terms, such description is for illustrative purposes only, and it is to be understood that changes and variations may be made without departing from the spirit or scope of the appended claims.

What is claimed is:

1. A source driver circuit for driving a plurality of data lines of a liquid crystal panel, comprising
a plurality of source amplifiers, which are arranged for each of the plurality of data lines and which generate a drive voltage corresponding to brightness data indicating pixel brightness, to supply corresponding data lines; wherein
each source amplifier comprises:
an output terminal to which a corresponding data line is connected;
a high side transistor arranged between a first power supply line and the output terminal;
a low side transistor arranged between a second power supply line and the output terminal;
a first capacitor arranged between the output terminal and a control terminal of the high side transistor; and
a second capacitor arranged between the output terminal and a control terminal of the low side transistor; and wherein
plural pads that function as output terminals of the plurality of source amplifiers are disposed along at least one side of a semiconductor substrate in which the source driver circuit is integrated, and the first capacitor and the second capacitor are disposed along the one side, at positions adjacent to the pads.

2. The source driver circuit according to claim 1, wherein the first capacitor and the second capacitor of each source amplifier are disposed on either side of a pad that functions as an output terminal of the source amplifier.
